(19) United States
(12) Patent Application Publication
(10) Pub. No.: US 2024/0347056 A1
(43) Pub. Date: Oct. 17, 2024

(54) VOICE-BASED AUGMENTED REALITY LOCOMOTION

(71) Applicant: International Business Machines Corporation, Armonk, NY (US)

(72) Inventors: Wei Jun Zheng, Shanghai (CN); Xiao Xia Mao, Shanghai (CN); Yuan Jin, Shanghai (CN); Qing Lu, Shanghai (CN); Xiao Feng Ji, Shanghai (CN); Steven Lee Fisher-Stawinski, Buffalo Grove, IL (US)

(21) Appl. No.: 18/301,368

(22) Filed: Apr. 17, 2023

(51) Int. Cl. G10L 15/22; G10L 15/02

(52) U.S. Cl. CPC G10L 15/22; G10L 15/02; G10L 2015/223

(57) ABSTRACT

Techniques are described with respect to a system, method, and computer product for voice-based augmented reality locomotion. An associated method includes receiving a first linguistic input; and determining a label and a duration associated with the linguistic input based on an analysis of the first linguistic input. The method further including converting the label into a heading and the duration into a magnitude in a virtual environment; and merging the heading and magnitude in a vector in the virtual environment.

### FIELD

This disclosure relates generally to computing systems and augmented reality, and more particularly to computing systems, computer-implemented methods, and computer program products configured to provide voice-based locomotion in virtual spaces.

Augmented reality (AR) and/or virtual reality (VR) allow a user to experience artificial sensory simulations that are provided with assistance by a computer which also creates a simulation of a physical world using immersive multimedia. The immersive multi-media provides outputs that are detected by a user's vision, hearing, and other senses, in order to give the user the illusion of experiencing a real physical world, rather than simply seeing and/or hearing a representation of the physical world. However, movement of a user (i.e., a representation of a user) within virtual environments may be impacted and/or limited in instances in which the user possesses various impediments. For example, if a user has limited range of motion/mobility or the user's hands/arms are preoccupied, then making physical gestures that translate into locomotion is impacted; thus, directly impacting the user's ability to migrate virtual environments.

### SUMMARY

Additional aspects and/or advantages will be set forth in part in the description which follows and, in part, will be apparent from the description, or may be learned by practice of the invention.

Embodiments relate to a method, system, and computer readable medium for voice-based augmented reality locomotion. In some embodiments, the computer-implemented method for voice-based augmented reality locomotion comprising receiving a first linguistic input; determining a label and a duration associated with the linguistic input based on an analysis of the first linguistic input; converting the label into a heading and the duration into a magnitude in a virtual environment; and merging the heading and magnitude in a vector in the virtual environment.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a virtual locomotion system environment, according to an exemplary embodiment;

FIG. 3 illustrates a block diagram showing a locomotion module and an augmented reality module of the virtual locomotion system of FIG. 1, according to an exemplary embodiment;

FIG. 4 illustrates a schematic diagram showing a plurality of locomotion axes within a virtual environment, as viewed through a computer-mediated reality device, according to an exemplary embodiment;

FIG. 5 illustrates a schematic diagram showing locomotion of a user within the virtual environment of FIG. 4 based on linguistics, according to an exemplary embodiment; and

FIG. 6 illustrates a flowchart depicting a method for voice-based augmented reality locomotion, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for voice-based augmented reality locomotion. Virtual reality (“VR”), augmented reality (“AR”), and/or mixed reality technologies provide computer-generated simulations that integrate real-world sensory input with overlaid computer-generated elements, such as sounds, videos, images, graphics, etc. allowing users to interact with, move around, and otherwise experience virtual environments from the user's perspective. Traditionally, users are represented in the virtual environment via virtual representations such as avatars configured to traverse the virtual environments based on one or more detecting gestures of the user's limbs. For example, users may perform gestures such as, but not limited to head bobbing, hand waving, arm swinging, etc., which translates to movements that allow traversal of the virtual environments. However in the instances in which a user has impediments (e.g., movement limitations, preoccupied hands, etc.), the user's ability to perform gesture based locomotion within virtual environments is directly impacted. Thus, the present embodiments have the capacity to improve locomotion within virtual environments for users with impediments by providing techniques that not only maintain locomotion axes that support interactions with users within virtual environments, but also receives, analyzes, and converts linguistic inputs into vectors that function as parameters for interaction commands within virtual environments. As a result, said users are able to navigate virtual environments in a manner that circumvents applicable impediments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described herein, virtual reality (“VR”) refers to a computing environment configured to support computer-generated objects and computer mediated reality incorporating visual, auditory, and other forms of sensory feedback. It should be noted that a VR environment may be provided by any applicable computing device(s) configured to support a VR, augmented reality, extended reality, and/or mixed reality user interacting with their surroundings, said interactions including but not limited to user movement/gazing, manipulation of virtual and non-virtual objects, or any other applicable interactions between users and computing devices known to those of ordinary skill in the art.

As described herein, augmented reality is technology that enables enhancement of user perception of a real-world environment through superimposition of a digital overlay in a display interface providing a view of such environment. Augmented reality enables display of digital elements to highlight or otherwise annotate specific features of the physical world based upon data collection and analysis. For instance, augmented reality can provide respective visualizations of various layers of information relevant to displayed real-world scenes.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

The following described exemplary embodiments provide a system, method and computer program for voice-based augmented reality locomotion.

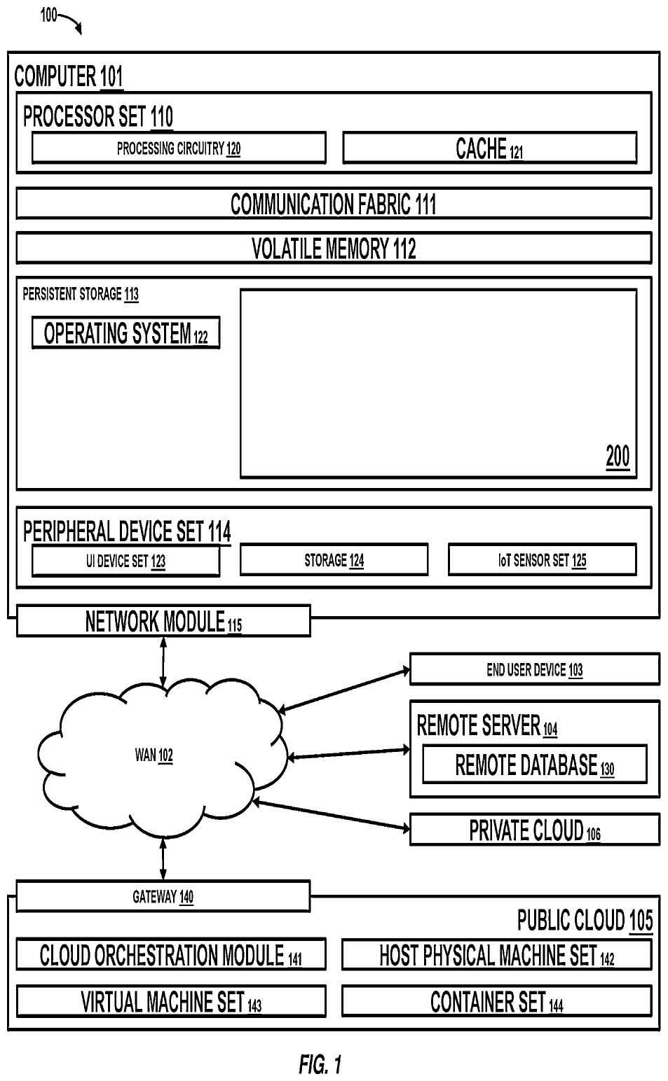

Referring now to FIG. 1, a computing environment 100 contains an example of an environment for the execution of at least some of the computer code involved in performing the inventive methods, such as block 200. In addition to block 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

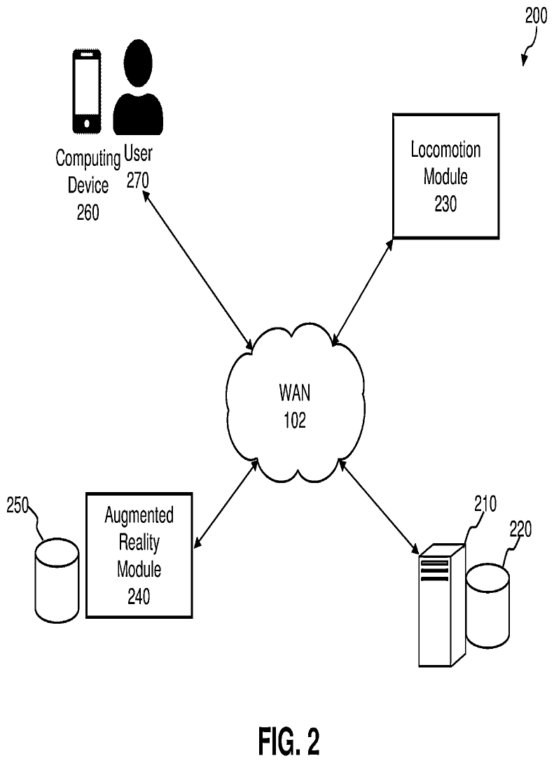

Referring now to FIG. 2, a functional block diagram of a networked computer environment illustrating a computing environment for a virtual locomotion system 200 (hereinafter “system”) comprising a server 210 communicatively coupled to a database 220, a locomotion module 230, an augmented reality module 240 comprising an augmented reality module database 250, and a computing device 260 associated with a user 270, each of which are communicatively coupled over WAN 102 (hereinafter “network”) and data from the components of system 200 transmitted across the network is stored in database 220.

In some embodiments, server 210 is configured to operate a centralized platform serving as a cloud-based augmented reality locomotion system designed for user 270 to access on computing device 260 and any other applicable computing devices which support user interfaces and application programming interfaces (APIs). In a preferred embodiment, the centralized platform is an augmented reality-based platform designed to provide locomotion techniques to user 270 via overlays, interactive virtual content, virtual objects, etc. within virtual environments maintained by augmented reality module 240 that receives one or more interactions from user 270 (e.g., linguistic inputs, utterances, etc.). The interactions are designed to be received, analyzed, and ultimately merged into a vector, in which the vector is a parameter to an interaction command in the virtual environment. Prior to the merging step, a label and a duration are ascertained from the analysis of the received interaction, in which the label is converted into a heading and the duration is converted into a magnitude in a virtual environment. For example, if user 270 was to utter “move directly ahead” while tilting his/her head forward, then the received interaction would ultimately be converted into a parameter to an interaction command to move forward in a particular direction at a specific magnitude from an origin point to a destination within the applicable virtual environment.

Locomotion module 230 is tasked with receiving and analyzing interactions from user 270 along with render mechanisms to support modulations of interactions within virtual environments. Locomotion module 230 may communicate with augmented reality module 240 in order to receive a plurality of sensor data necessary for locomotion module 230 to process interactions and/or augmented reality module 240 to render the applicable virtual environment. In some embodiments, locomotion module 230 interprets and renders user interactions with the virtual environment in which the interactions correspond with one or more movements in accordance with a plurality of axes in two dimensional, three dimensional, and/or four dimensional plane.

In some embodiments, locomotion module 230 is further designed to maintain a data store for predetermined reference headings associated with labels derived from the received interaction, in which the reference headings are stored in database 220 and searched for based on queries derived from the determined label ascertained from the processing of the interactions, in which the reference headings are indicators of directions of movement of user 270 within virtual environments. Server 210 is configured to continuously update the data store with labels and headings in which the labels are reference directions configured to be conveyed to user 270 over computing device 260 via overlays within the applicable virtual environment generated by augmented reality module 240. Locomotion module 230 maintains a plurality of axes, each of which include a heading ascertained from translation of a label derived from the user interaction, such as the linguistic input. Upon ascertaining the label and the duration from the user interaction, locomotion module 230 translates the label into at least one heading of the axes and the duration into a magnitude within the applicable virtual environment for user 270 to traverse from an origin point to a destination point.

Augmented reality module 240 is tasked with generating AR-based virtual environments (e.g., a virtual reality model of the scene/environment or superimposing virtual content over a real world view of the scene in augmented reality) for user 270 to navigate. It should be noted that interaction commands are interactions between user 270 and the applicable virtual environment via computing device 260 that trigger one or more activities associated with a virtual representation (i.e., an avatar) of user 270, examples of interaction commands include, but are not limited to interacting with virtual objects, traversing from one point of a virtual environment to another, reducing volume of AR experience, reducing thresholds for commands (e.g., volume command threshold, etc.), or any other applicable interaction commands known to those of ordinary skill in the art. Augmented reality module 240 may utilize various mechanisms and techniques known to those of ordinary skill in the art to present virtual content, and in particular overlays the plurality of axes over the virtual environments and its content supporting traversing of the virtual environment based on processing of the user interaction. In some embodiments, virtual environments rendered by augmented reality module 240 comprise a plot of non-spatial dimensional data, in which the vector represents a coordinate visualizing the non-spatial data within a virtual environment.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network or querying a database.

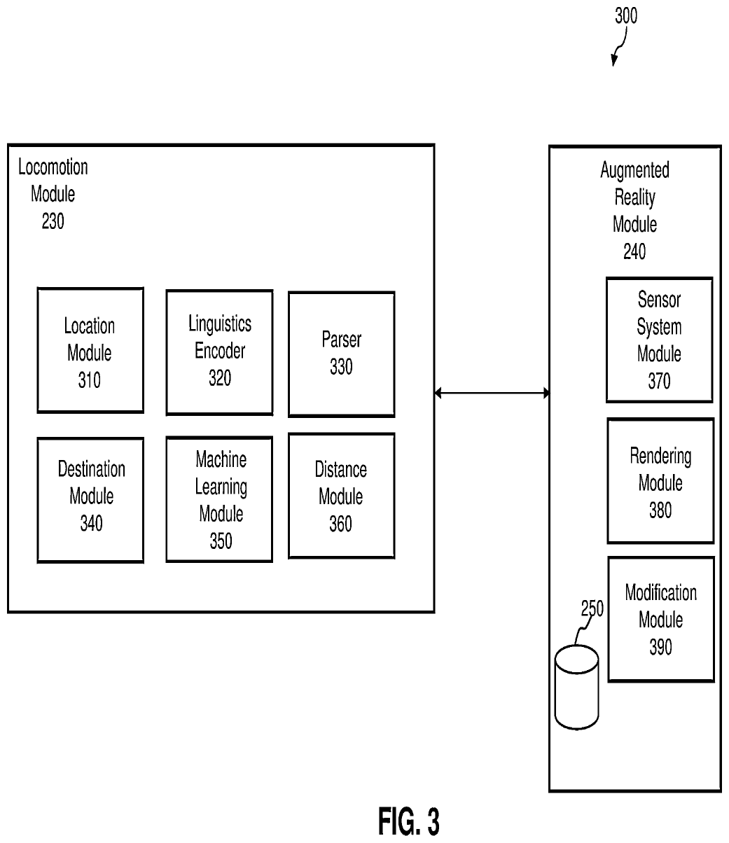

Referring now to FIG. 3, locomotion module 230 and augmented reality module 240 are depicted, accordingly to exemplary embodiment. In some embodiments, locomotion module 230 comprises a location module 310, an encoder 320, a parser 330, a destination module 340, a machine learning module 350, and a distance module 360. Augmented reality module 240 comprises a sensor system module 370, a rendering module 380, and a modification module 390, each of which communicate with each other over the network.

Location module 310 is tasked with tracking the location of user 270 within the applicable virtual environment via monitoring the global positioning of computing device 260 along with the virtual environment position of user 270 with respect to virtual objects and other reference points within the virtual environment (e.g., landmarks, etc.). It should be noted that one primary purpose of location module 310 monitoring the location of user 270 within the virtual environment is to establish an origin point and a destination within the virtual environment. In some embodiments, user 270 is able to traverse from the origin point to the destination based on the heading and magnitude derived from converting the label and the duration, each of which are ascertained from processing an interaction of user 270. For example in the instance in which the interaction is a linguistic input, the processing of the linguistic input results in user 270 specifying the desired direction and duration of movement in said direction in order to move from the origin point to the destination. In some embodiments, location module 310 assigns an origin code to the origin point within a plot, graph, and the like; in which the plurality of axes are allocated to the virtual environment for presentation to user 270 based on non-spatial dimensional data associated with the virtual environment determined by location module 310.

Encoder 320 is tasked with receiving and encoding interactions from user 270 via one or more inputs received by computing device 260 and/or sensor system module 370. Inputs may include but are not limited to voice/audio inputs, linguistic inputs, text-based inputs, gesture-based inputs, or any other applicable types of inputs known to those of ordinary skill in the art. In some embodiments, encoder 320 may comprise a plurality of configurations subject to the overall setup of locomotion module 230. For example, encoder 320 may include a linear embedding layer, followed by one-dimensional convolutional layers, and a long short-term memory (LSTM) layer or any other applicable configuration. Outputs of encoder 320 may be a sequence of embedding vectors or any other applicable outputs known to those of ordinary skill in the art. In some embodiments, receiving and processing linguistic inputs may result in determination of one or more interaction commands including but not limited requests of user 270 to stop, go, slow down, speed up, zoom in, zoom out, and the like within the virtual environment.

Parser 330 is tasked with analyzing and parsing the interactions, such as linguistic inputs in order to ascertain a label and a duration within a linguistic input. For example, user 270 provides a first utterance “E” indicating desire to traverse in the direction of the applicable axis bearing the label “E” of the plurality of axes at a first duration from the origin point, in which the conversion of the label into a heading by destination module 340 and the conversion of the first duration into a magnitude by distance module 360 within the virtual environment result in a merging of the heading and magnitude into a vector associated with a vector direction representing movement of user 270 within the virtual environment. Continuing on the previous example, user 270 provides a second utterance “EEEEE” indicating based on the analysis by parser 330 the desire to traverse in the direction of the axis bearing the label “E” of the plurality of axes at a second duration from a second point extending from the origin point in the direction of the “E” axis, in which the second duration ascertained by parser 330 indicates a greater magnitude than that of the first duration based upon distance module 360 converting the second duration into a magnitude of movement from the second point towards the direction of the destination. In some embodiments, parsing of linguistic inputs by parser 330 to remove redundant portions of the linguistic input in order to ascertain the label and duration. Parser 330 may communicate with machine learning module 350 to transmit neural word embeddings as inputs into machine learning models operated by machine learning module 350 based on the LSTM in order to identify long range dependencies between parsed keywords (e.g., a letter, a direction, a duration, a heading, etc.). It should be noted that parsing of the linguistic inputs may include detecting tokens within the linguistic inputs for the ascertaining of action statements, durations, and corresponding elements within the linguistic inputs; however, a major purpose of the parsing is to assist with extracting of a label and a duration from the linguistic input.

Destination module 340 is tasked with converting the label ascertained by parser 330 into a heading. In addition to destination module 340 converting the label into a heading, destination module 340 also interprets, via translation, the heading in a virtual environment of arbitrary dimensions by searching for a predetermined reference heading associated with the detected ascertained label in the data store maintained by locomotion module 230. In some embodiments, selection of a heading within a virtual environment may be accomplished by user 270, in which a head tilt in the direction of the axis associated with the heading is detected by the applicable sensor of computing device 260 allowing destination module 340 to determine the applicable heading representing the direction of movement of user 270 within the virtual environment. It should be noted that destination module 340 designates the heading to computing device 260 (i.e., a computer-mediated reality device) resulting in user 270 being able to select an axis within the virtual environment to set their desired direction of view on arrival before initiating the move from the origin point. In some embodiments, destination module 340 generates a mapping which serves as a plot generated based on non-spatial dimensional data representing a space of arbitrary dimensions designed for allocation coordinates for visualization of the non-spatial dimensional data.

Machine learning module 350 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. In some embodiments, machine learning module 350 is configured to generate vectors associated with vector directions representing movements of users within the virtual environment by merging the headings and magnitudes ascertained from the labels and durations derived from linguistic inputs. It should be noted that the merging of a heading representing a label and a magnitude representing a duration not only results in a vector, but also a parameter to an interaction command within the virtual environment. Therefore, the interaction command translates into a movement of user 270 in particular direction at a particular magnitude within a virtual environment.

In some embodiments, determination of a label and a duration may be supported by one or more machine learning models operated by machine learning module 350 designed to outputs predictions indicating contextual data relating to a desired movement of user 270 within the virtual environment. For example, user 270 may be within a virtual environment in which various virtual objects may be surrounding and the one or more machine learning models may utilize training datasets derived from historical activities of user 270, preferences of user 270, virtual environment-based data (e.g., virtual environment historical layouts, historical gaze detections of AR users, virtual objects likely to draw attention, etc.) derived from augmented reality module 240 stored in augmented reality module database 250, internet-based data sources derived from one or more crawlers associated with server 210 (e.g., social media data, etc.). Outputs of the one or more machine learning models are generated indicating labels and durations configured to be converted into headings and magnitudes for merging into vectors based on the contextual data in combination with the analysis on the applicable linguistic input, in which the direction of the vector may be based upon the virtual objects and/or areas of focus within the perspective of user 270.

Distance module 360 is tasked with conversion of a duration derived from analysis of a linguistic input into a magnitude. It should be noted that the magnitude is a quantifiable metric of movement within a particular direction in the virtual environment. For example, the magnitude is configured to reflect the amount of distance in a particular direction that user 270 will move within the virtual environment. In some embodiments, magnitude of the movement may be conditioned upon axis selection in which user 270 sets the desired direction of view on arrival to a destination within the virtual environment prior to initiating the movement. Similarly, distance module 360 may interpret the magnitude of the vector as camera zoom derived from computing device 260 and/or sensor system module 370. For example, user 270 may zoom in on a destination or computing device 260 may detect a direction of gaze within the virtual environment, allowing distance module 360 to establish the magnitude based on calculating the distance between the origin point or current position according to the non-spatial dimensional data and the destination within the virtual environment.

Sensor system module 370 is a collection of one or more sensor systems of augmented reality module 240 designed to collect sensor data via applicable associated computing devices, such as computing device 260, for the purpose of analyzing and generating virtual environments for user 270 to traverse through. The one or more sensor systems may include, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IOT”) sensors, or any other applicable type of sensors known to those of ordinary skill in the art. For example, computing device 260 may comprise a microphone configured to receive the linguistic inputs allowing sensor system module 370 to process interaction commands.

Rendering module 380 is configured to generate the plurality of axes overlayed in the virtual environment being experienced by user 270. The selection of the plurality of axes allows the vector to represent a coordinate visualizing the non-spatial dimensional data within the virtual environment. In some embodiments, each of the axes are associated with a direction of movement within the virtual environment resulting in the magnitude of the vector to function similarly to an input of an analog stick; however the duration input derived from the analyzing of the linguistic input is configured to be applied to three or more dimensions to support traversal in a variety of directions within the virtual environment. Presentation of the plurality of axes may be subject to a plurality of various factors including but not limited to current position of user 270 within the virtual environment, gaze direction of user 270 derived from computing device 260 (e.g., target orientation of the field of view of computer-mediated reality device), analyses of the linguistic input, or any other applicable orientation based known to those of ordinary skill in the art. For example, an orientation of user 270 may be ascertained by sensor system module 370 resulting in rendering module 380 overlaying the plurality of axes over the field of view of user 270 allowing selecting of the axis that renders the vector of movement with the virtual environment desired by user 270.

Modification module 390 is configured to account for modifications to the direction and/or distance traversed by user 270. It should be noted that the modifications may be based upon analysis of subsequent linguistic inputs received by locomotion module 230 in addition to gesture-based inputs detected by computing device 260. Modification module 390 is configured to take into account orientation data along with other applicable data received by computing device 260 in order to modify a vector in accordance with a second/subsequent linguistic input or applicable interaction processed by locomotion module 230. In some embodiments modifications to the vector are initiated based on modification module 390 detecting voice commands of user 270 in real time resulting in modification being applied to the vector in real-time. For example while traversing through the virtual environment in accordance with a vector, user 270 may provide an interaction command to computing device 260 in the form of an utterance to “stop moving”, in which locomotion module 230 processes the utterance and subsequently modification module 390 modifies the completion of the vector by stopping user 270 in their current position within the virtual environment. In another example, user 270 may provide an interaction command to computing device 260 in the form of an elongated utterance to “eeeeeeee” representing the applicable associated axes, in which locomotion module 230 interprets the elongated utterance as an interaction command to further the distance to be traversed and in some instances increase the speed of the movement of user 270 based upon amount of elongation of the utterance. In other words, the longer user 270 holds the utterance the longer the faster and/or the further user 270 moves within the virtual environment due to modification module 390 modifying the applicable vector. Furthermore, locomotion module 230 may further support an inertia and/or acceleration build up feature allowing user 270 to start moving slowly and then accelerate as long as the vocalization is held, and when user 270 stops vocalizing locomotion module 230 reduces the amount of speed and stops movement of user 270 within the virtual environment over a period between a few tenths of seconds and a few seconds. This feature enables user 270 to take a breath during a longer journey, since they can end the vocalization briefly to take a breath and resume before they decelerate all the way to zero.

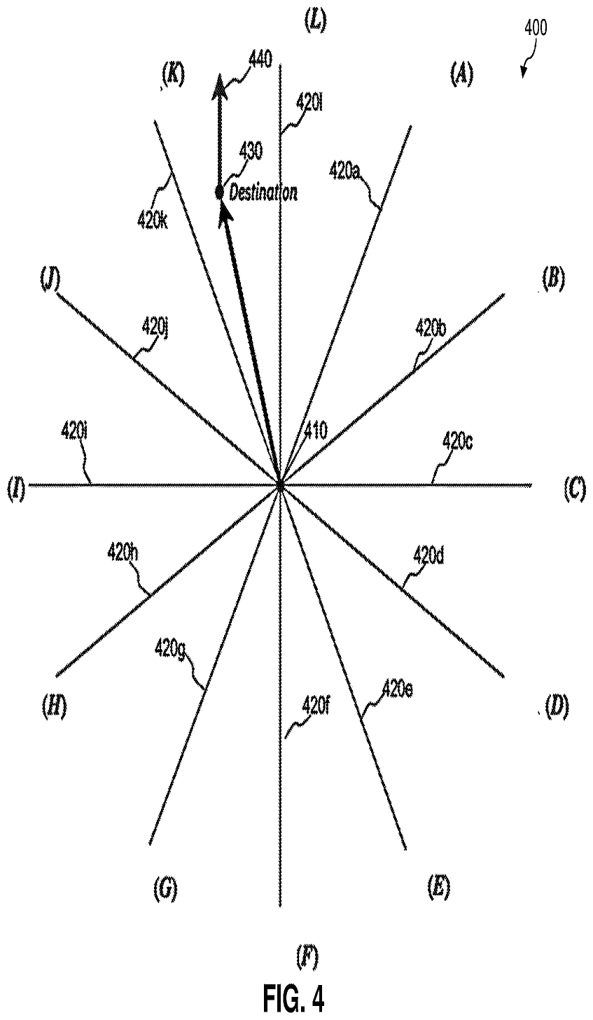

Referring now to FIG. 4, a plurality of axes 400 generated by rendering module 380 configured to be overlayed on a three dimensional virtual environment is depicted, according to an exemplary embodiment. As depicted, axes 400 comprises a plurality of headings 420a-420l generated and assigned by locomotion module 230 based on the processing of linguistic inputs, in which each of axes 400 comprises one of headings 420a-420l extending from an origin point 410 indicating the current location of user 270 within the virtual environment. In some embodiments, user 270 may preemptively select moves within the virtual environment allowing modification module 390 to nudge the direction of the vector between headings 420a-420l. In addition, modification module 390 may receive instructions from locomotion module 230 to apply an adjustment interaction command derived from the second linguistic input allowing modification module 390 to apply the adjustment interaction command to modify an angle of a predetermined reference heading by an amount proportional to the adjustment duration derived from the second linguistic input. It should be noted that headings 420a-420l may ascertained by rendering module 380 from the data store for predetermined reference headings maintained by locomotion module 230, in which predetermined reference headings may be configured by user 270 on the centralized platform and/or server 210 may generate them based on orientation data associated with user 270 within the virtual environment.

Headings 420a-420l are depicted within the field of view of user 270 allowing selection of the axis that renders the vector of movement with the virtual environment desired by user 270. Headings 420a-420l may be interactive virtual objects, toggles, and the like applied to the virtual environment. According to one embodiment, a three-dimensional virtual keyboard and/or mechanism configured to select inputs of user 270 (e.g., gesture detection, voice command analysis, etc.) may be utilized when user 270 selecting characters. User 270 may input the desired direction of traversal via typing or verbally uttering the character associated with the applicable heading of the desired direction for traversal. For example, user may wish to utter and/or input (via the virtual keyboard) the character “K”, in which user 270 interacts with the virtual environment by moving along axis 420k until user 270 arrives at first destination 430 or modification module 390 receives instructions to generate an adjustment interaction command derived from analysis of a subsequent linguistic input. In some embodiments, modification module 390 utilizes orientation data associated with user 270 derived from computing device 260 along with plotting of non-spatial dimensional data in order to adjust/align spacing, presentation, and the like of axes 400. Location module 310 may determine that user 270 has reached first destination point 430 or second destination point 440 by determining user 270 has been idle in one spot for a pre-configured period of time, user 270 interacting with the virtual environment (e.g., interacting with a virtual object at the location, performing a gesture to stop with hands, head, or other applicable body part, etc.), or user 270 initiating an input (e.g., pressing a button, etc.), and the like.

Since augmented reality systems may be more accurate when capturing movements in a one-or two-dimensional space, movements of user 270 along one axis of the three-dimensional virtual environment may be initially monitored to capture one or more gestures indicating selection of a label and determination of a duration derived from linguistic inputs. For example, user 270 may select the first heading for a movement in direction within virtual space from origin point 410 with the goal of traversing to a first destination point 430 within the virtual environment. A subsequent gesture made by user 270 (i.e., a nod of the head) may be analyzed by locomotion module 230 as the adjustment interaction command to proceed by selecting the applicable heading of headings 420a-420l to traverse user 270 to a second destination point 440. Furthermore, modification module 390 may continuously re-allocate axes 400 to the virtual environment based on the orientation of user 270 derived from location module 310, in which the re-allocation is in real-time and the vector directions align according to the orientation, position, virtual objects, etc. associated with user 270. Utilizing the data store for predetermined reference headings, headings relative to the direction of a virtual object within the view of user 270 may be displayed along a perpendicular axis of the xyzn plane generated by rendering module 380 based on the non-spatial dimensional data.

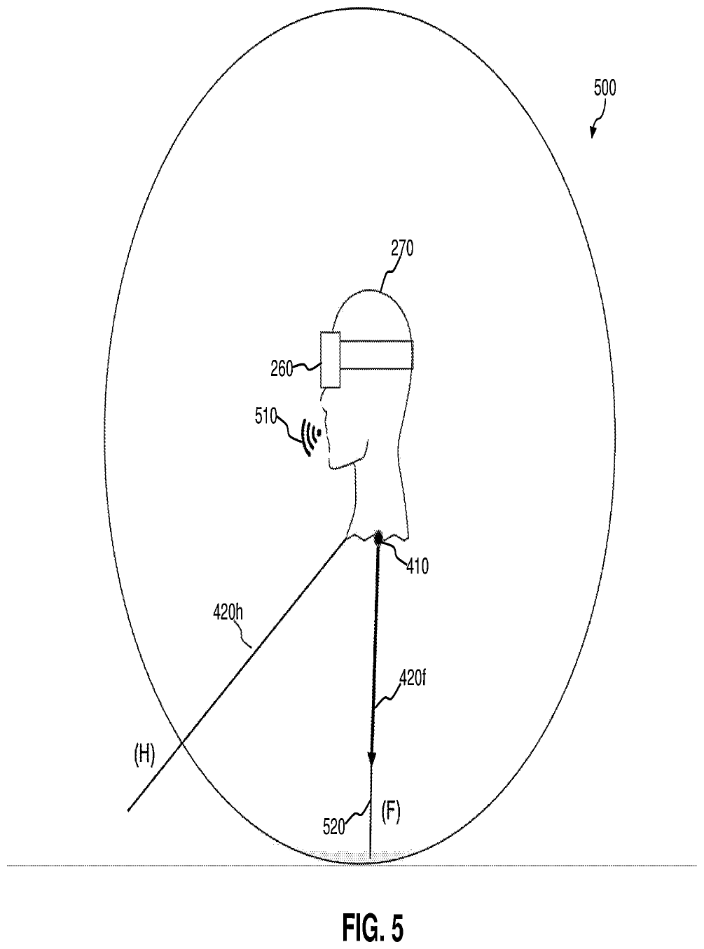

Referring now to FIG. 5, a diagram 500 of locomotion of user 270 within the virtual environment is depicted, according to an exemplary embodiment. It should be noted that user 270 is located at origin point 410 within the virtual environment in which an avatar, virtual object, and/or any other applicable type of virtual representation of an augmented reality experience user may traverse within the virtual environment on behalf of user 270. In particular, the applicable vector the virtual representation traverses represents a direction and distance of motion, and the interaction command is configured to move an avatar within the virtual environment in accordance with the vector. For example, user 270 utters linguistic input 510 in which locomotion module 230 processes linguistic input 510 in order to ascertain a label (i.e., a direction of movement) and a duration (i.e., how much of the movement in the direction). The label may be a “+1/−1” established based on the selected letter associated with an axes and duration the utterance is held.

Based on the analyzed linguistic input, destination module 340 converts the label into heading 420f and distance module 360 converts the duration into a magnitude from origin point 410. Heading 420f and the magnitude are merged by machine learning module 350 resulting in a vector including a vector direction representing movement of user 270 within the virtual environment along the applicable axis associated with heading 420f and a parameter to an interaction command. Upon receiving a second linguistic input for extracting an adjustment interaction command and an adjustment duration; a gesture from user 270 (e.g., a head nod, hand stop motion, etc.); and/or a secondary input on the three-dimensional virtual keyboard from user 270, modification module 390 generates a modification to an angle 520 pertaining to the predetermined reference heading associated with heading 420f by an amount proportional to the adjustment duration. For example, if the second linguistic input includes the utterance “FFFFFFF”, then distance module 360 quantifies the adjustment duration based on the parsing performed by parser 330 and calculates the amount to modify angle 520 in relation to the adjustment duration. Distance module 360 is further configured to apply adjustment interaction commands based on detecting and analyzing the gaze of user 270 within the virtual environment. For example, the aforementioned supports the gaze of user 270 to function as a steering mechanism allowing the gaze to dictate the selection of headings 420a-420l and the ascertained duration and/or applicable gesture/user input to determine the magnitude.

In some embodiments, rendering module 380 communicates with machine learning module 350 in order to receives predictions pertaining to align, presentation, etc. of vectors based on various factors such as orientation data, previous virtual objects interacted with by user 270, gaze detection of user 270, etc. For example, location module 310 detects user 270 at origin point 410, and based on one or more analyses of the virtual environment performed by augmented reality module 240 machine learning module 350 predicts that user 270 desires to go in the direction of either axis 420f or axis 420h based upon the virtual objects along the vector direction associated 420f or axis 420h. Locomotion module 230 may further apply progressive/iterative deceleration to the magnitude based upon detecting pauses or slower instances of speech when user 270 is talking in order to accommodate breathes and the like without stopping the interaction command altogether.

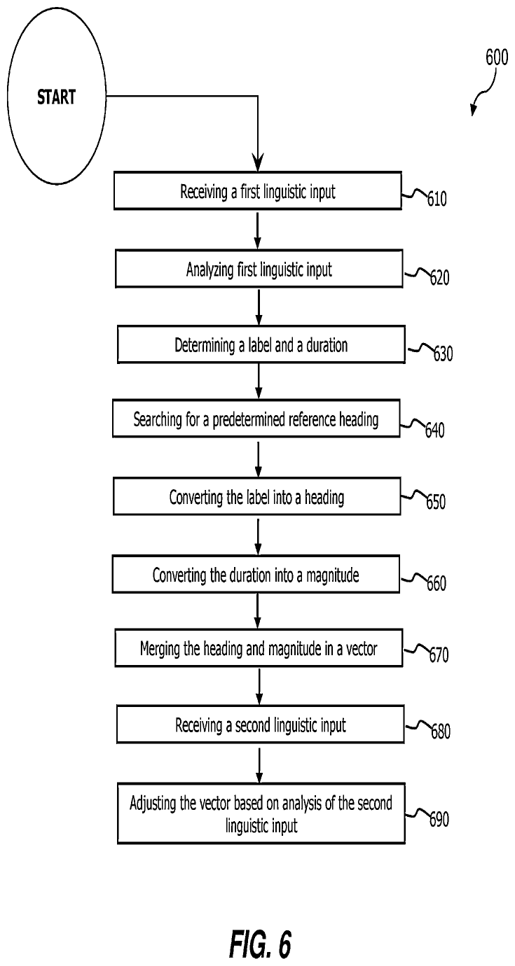

With the foregoing overview of the example architecture, it may be helpful now to consider a high-level discussion of an example process. FIG. 6 depicts a flowchart illustrating a computer-implemented process 600 for a method for voice-based augmented reality locomotion, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, locomotion module 230 receives a first linguistic input. Interactions may be sourced from inputs on the centralized platform, one or more of computing device 260, applicable data sources provided by server 210, voice command devices, extended reality devices, head-mounted displays, virtual glasses/goggles, artificial intelligence voice assistance systems, smart speakers, or any other applicable type of computing device. It should be noted that locomotion module 230 is configured to receive interactions in which the interaction may include linguistic inputs, text-based inputs, gesture-based inputs, or any other applicable types of inputs known to those of ordinary skill in the art.

At step 620 of process 600, locomotion module 230 analyzes the first linguistic input. It should be noted that subsequent inputs to that of the first linguistic input are configured to stop, pause, and/or modify the parameters of interaction commands in which the parameters may pertain to one or more of a vector, vector direction, label, duration, magnitude of movement, orientation, or any other applicable virtual/augmented technology-based parameters known to those of ordinary skill in the art.

At step 630 of process 600, parser 330 determines a label and a duration of the first linguistic input. The label may be ascertained by searching for a predetermined reference heading associated with the detected ascertained label in the data store maintained by locomotion module 230, in which the data store is continuously updated based on various factors such as but not limited to orientation data, calculated distances between virtual objects within the virtual environment, virtual environment layout configurations, and the like. The data store may further update the predetermined reference headings based on non-spatial dimensional data and the vector represents a coordinate visualizing the non-spatial dimensional data within the virtual environment. The non-spatial dimension data may be utilized to allocate plots representing the axes for the purpose of dictating vector directions for user 270 to traverse along xyz . . . n axes within the virtual environment.

At step 640 of process 600, locomotion module 230 performs the search for the predetermined reference heading. It should be noted that the search is based on a query derived from the label ascertained from the analysis of the first linguistic input, in which the query ensures that the associated heading exists in the data store and if the heading does not exist then the heading is created based on at least the position of user 270 within the virtual environment. In some embodiments, the search can be minimal in which there may be a hardcoded lookup table or an applicable case or switch statement in some code to determine what the appropriate heading to be selected is.

At step 650 of process 600, destination module 340 converts the label into a heading. The conversion of the label is based upon not only the results of the query of the data store for the predetermined reference heading, but also the non-spatial dimensional data allowing vectors to be visualized the within the virtual environment. It should be noted that non-spatial dimensional data may include data associated with various systems including, but not limited to music profiling systems, actuarial systems, healthcare systems (e.g., risk quantification systems), data aggregation entities, various types of scientific/engineering based data entities, or any other applicable data related to an entity configured to visualize elements based on parameters.

At step 660 of process 600, distance module 360 converts the duration into a

magnitude. The duration may be quantified in a plurality of manners including but not limited to paces, units of measurement, proximity to virtual objects, or any other applicable means to represent an amount of virtual traversing known to those of ordinary skill in the art. The magnitude may represent the amount of distance necessary to be traversed in order for user 270 to get from origin to a first destination point and/or a second destination point determined based upon a received adjustment duration and/or modification to the orientation of user 270 within the virtual environment.

At step 670 of process 600, machine learning module 350 merges the heading and the magnitude into a vector. It should be noted that the vector represents a direction and distance of motion of user 270 and the interaction command is configured to move an avatar within the virtual environment in accordance with the vector.

At step 680 of process 600, locomotion module 230 receives a second linguistic input. In some embodiments, locomotion module 230 receives a user input, a gesture, or any other applicable input configured to be processed by a VR, AR, XR, and/or mixed reality system. For example, while traversing along an axis associated with a heading in the virtual environment, user 270 may provide an utterance or other applicable user input to indicate a desire to speed up, slow down, stop, change direction, and/or alter traversal within the virtual environment.

At step 690 of process 600, modification module 390 adjusts the vector based on the analysis of the second linguistic input. Modification module 390 is configured to take into account orientation data along with other applicable data received by computing device 260 in order to modify a vector in accordance with a second/subsequent linguistic input or applicable interaction processed by locomotion module 230. Furthermore, modification module 390 may adjust the vector based on a zooming in/out feature provided to user 270 in which the gaze direction combined with the zooming function applied to a virtual object within the virtual environment allows modification module 390 to determine that adjustment interaction command and/or adjustment duration is necessary in order to accurately modify the angle and/or speed for user 270 to reach the destination point.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for voice-based augmented reality locomotion, the method comprising:
receiving, by a computing device, a first linguistic input;
determining, by the computing device, a label and a duration associated with the linguistic input based on an analysis of the first linguistic input;
converting, by the computing device, the label into a heading and the duration into a magnitude in a virtual environment; and
merging, by the computing device, the heading and magnitude in a vector in the virtual environment.

2. The computer-implemented method of claim 1, wherein the vector is a parameter to an interaction command in the virtual environment.

3. The computer-implemented method of claim 1, wherein the vector is associated with a vector direction representing movement of a user within the virtual environment.

4. The computer-implemented method of claim 2, wherein the vector represents a direction and distance of motion and the interaction command is configured to move an avatar within the virtual environment in accordance with the vector.

5. The computer-implemented method of claim 1, wherein the virtual environment comprises a plot of non-spatial dimensional data and the vector represents a coordinate visualizing the non-spatial dimensional data within the virtual environment.

6. The computer-implemented method of claim 1, wherein converting the label into a heading and the duration into a magnitude comprises:
searching, by the computing device, a data store for a predetermined reference heading associated with the label.

7. The computer-implemented method of claim 6, wherein merging the heading and magnitude in a vector comprises:
receiving, by a computing device, a second linguistic input;
extracting, by the computing device, an adjustment interaction command and an adjustment duration based on an analysis of the second linguistic input; and
applying, by the computing device, the adjustment interaction command to modify an angle of the predetermined reference heading by an amount proportional to the adjustment duration.

8. A computer program product for voice-based augmented reality locomotion, the computer program product comprising one or more computer readable storage media and program instructions collectively stored on the one or more computer readable storage media, the stored program instructions comprising:
program instructions to receive a first linguistic input;
program instructions to determine a label and a duration associated with the linguistic input based on an analysis of the first linguistic input;
program instructions to convert the label into a heading and the duration into a magnitude in a virtual environment; and
program instructions to merge the heading and magnitude in a vector in the virtual environment.

9. The computer program product of claim 8, wherein the vector is a parameter to an interaction command in the virtual environment.

10. The computer program product of claim 8, wherein the vector is associated with a vector direction representing movement of a user within the virtual environment.

11. The computer program product of claim 9, wherein the vector represents a direction and distance of motion and the interaction command is configured to move an avatar within the virtual environment in accordance with the vector.

12. The computer program product of claim 8, wherein program instructions to convert the label into a heading and the duration into a magnitude comprise:
program instructions to search a data store for a predetermined reference heading associated with the label.

13. The computer program product of claim 12, wherein program instructions to merge the heading and magnitude in a vector comprise:
program instructions to receive a second linguistic input;
program instructions to extract an adjustment interaction command and an adjustment duration based on an analysis of the second linguistic input; and
program instructions to apply the adjustment interaction command to modify an angle of the predetermined reference heading by an amount proportional to the adjustment duration.

14. A computer system for voice-based augmented reality locomotion, the computer system comprising:
one or more processors;
one or more computer-readable memories;
program instructions stored on at least one of the one or more computer-readable memories for execution by at least one of the one or more processors, the program instructions comprising:
program instructions to receive a first linguistic input;
program instructions to determine a label and a duration associated with the linguistic input based on an analysis of the first linguistic input;
program instructions to convert the label into a heading and the duration into a magnitude in a virtual environment; and
program instructions to merge the heading and magnitude in a vector in the virtual environment.

15. The computer system of claim 14, wherein the vector is a parameter to an interaction command in the virtual environment.

16. The computer system of claim 14, wherein the vector is associated with a vector direction representing movement of a user within the virtual environment.

17. The computer system of claim 15, wherein the vector represents a direction and distance of motion and the interaction command is configured to move an avatar within the virtual environment in accordance with the vector.

18. The computer system of claim 14, wherein the virtual environment comprises a plot of non-spatial dimensional data and the vector represents a coordinate visualizing the non-spatial dimensional data within the virtual environment.

19. The computer system of claim 14, wherein program instructions to convert the label into a heading and the duration into a magnitude comprise:
program instructions to search a data store for a predetermined reference heading associated with the label.

20. The computer system of claim 14, wherein program instructions to merge the heading and magnitude in a vector comprise:
program instructions to receive a second linguistic input;
program instructions to extract an adjustment interaction command and an adjustment duration based on an analysis of the second linguistic input; and
program instructions to apply the adjustment interaction command to modify an angle of the predetermined reference heading by an amount proportional to the adjustment duration.
